(19) United States
(12) Patent Application Publication
(10) Pub. No.: US 2020/0093572 A1
(43) Pub. Date: Mar. 26, 2020

(54) SYSTEMS AND METHODS FOR REDUCING ROOT RESORPTION IN ORTHODONTIC TREATMENT

(71) Applicant: Advanced Orthodontics and Education Association, LLC., Ossining, NY (US)

(72) Inventors: Bryce Way, San Jose, CA (US); Richard Johnson, Briarcliff Manor, NY (US)

(73) Assignee: Advanced Orthodontics and Education Association, LLC, Ossining, NY (US)

(21) Appl. No.: 16/139,268

(22) Filed: Sep. 24, 2018

(51) Int. Cl. A61C 7/00; A61C 7/08

(52) U.S. Cl. CPC A61C 7/008; A61C 8/0006; A61C 7/08

(57) ABSTRACT

Embodiments of the present disclosure are directed to devices and methods for reducing root resorption during clear aligner treatment with vibration. According to various implementations, a vibrational dental device configured to vibrate at a frequency of about 120. Hz may be obtained. Subjects undergoing clear aligner treatment may be treated for about five minutes daily with the exemplary vibrational dental device. The extend of root resorption of the four incisors may be reduced by the vibration, while maintaining desired movement of the teeth during orthodontic treatment.

### BACKGROUND

### Technical Field

The present disclosure generally relates to dental devices and methods. More particularly, and without limitation, the disclosed embodiments relate to devices, systems, and methods for reducing orthodontically-induced apical root resorption.

### Background Description

Orthodontic treatment, such as with braces or clear aligners, is common in adults and teens wishing to improve their physical appearance and dental health. The American Association of Orthodontics estimates that millions of Americans undergo orthodontic treatment every year. However, apical root resorption is a complication commonly associated with orthodontic treatment. Root resorption, or pathological shortening of the dental root, can lead to permanent loss of root structure, resulting in pain, tooth mobility, tooth loss, and visible changes in the appearance of the teeth. It is believed that orthodontic forces transmitted through the tooth root to the periodontal ligament (PDL) may cause areas of compression and tension in the PDL. This in turn may lead to an influx of osteoclasts and osteoblasts, resulting in imbalance between resorption, deposition, and development of root resorption.

Due to the demonstrated association between orthodontic forces and root resorption, there is significant clinical interest in maximizing orthodontic effects while minimizing the resulting root resorption. One possibility may be to apply smaller forces on the teeth during orthodontic treatment. Paetyangkul, A. et al. (“Physical properties of root cementum: Part 14. The amount of root resorption after force application for 12 weeks on maxillary and mandibular premolars: A microcomputed-tomography study”), American Journal of Orthodontics and Dentofacial Orthopedics 136(4): 492e1-492e9 (2009), which is incorporated by reference herein, investigated root resorption associated with light (25 g) and heavy (225 g) orthodontic forces. Paetyangkul found that light forces produced significantly less root resorption than heavy forces. However, lighter orthodontic forces may require prolonged treatment time to achieve the desired tooth alignment. In addition, Paetyangkul found that in the case of light force application, increased treatment time was associated with significantly increased root resorption. Therefore, application of light orthodontic forces over a prolonged period of time is demonstrated to be an inefficient technique to minimize root resorption.

Other possible techniques to reduce root resorption may include surgery and injection of pharmaceutical agents into the roots of the teeth. However, such techniques are highly invasive, or interfere with the rate of tooth movement, or have not been demonstrated to effectively reduce root resorption. Abass et al. (“Orthodontics and External Apical Root Resorption”), Seminars in Orthodontics 13(4): 246-256 (2007). Thus, there remains a continued need for an effective technique to reduce root resorption during orthodontic treatment, such as during aligner treatment. Such a technique may achieve the desired tooth alignment by application of orthodontic forces while minimizing the extent of root resorption during treatment.

### SUMMARY

The embodiments of the present disclosure include devices, systems, and methods for reducing root resorption in orthodontic treatment, such as during aligner treatment, with mechanical stimulation, such as high-frequency vibration. Advantageously, the exemplary embodiments may minimize root resorption while achieving the desired tooth alignment with the orthodontic treatment.

According to an exemplary embodiment of the present disclosure, a method for reducing root resorption in aligner treatment is described. The method may include providing a vibrational dental device configured to vibrate at a frequency higher than about 80 Hz. The method may further include providing instructions for treating the teeth of a patient with orthodontic aligners. The aligners may be configured to be worn in the mouth of a patient in a pre-determined sequence to move the patient's teeth substantially into a desired alignment. The aligners can be programmed for movement over any clinically meaningful distance, stepwise with each aligner change. The exact distance moved is usually determined by software, with an example being 0.25 mm of anterior-posterior movement on a target incisor. The method may additionally include providing instructions for mechanically stimulating, using the vibrational dental device, the teeth of the patient for about five minutes daily while the patient is wearing the aligners.

In some embodiments, the vibrational dental device may be configured to vibrate at a frequency of about 120 Hz. The method may additionally include treating the teeth with each aligner in the pre-determined sequence. For each aligner, treatment may include placing a mouthpiece of the vibrational dental device within the mouth of the patient while the patient is wearing the aligner and activating a vibration source of the vibrational dental device for a predetermined period of time while the aligner contacts the mouthpiece. For example, the predetermined period of time may be less than about 20 minutes daily, 15 minutes daily, 10 minutes daily, 6 minutes daily, 5 minutes daily, 4 minutes daily, or less. It is contemplated that in other embodiments the period of time may be any value within the range of about 1 minute and 19 minutes daily, and that the daily total treatment time could be formed of a plurality of treatment sessions contributing to the daily total treatment time. In one exemplary embodiment, the daily total treatment time is about 5 minutes. The mechanical stimulation may reduce root resorption of the patient's teeth during aligner treatment.

According to another exemplary embodiment of the present disclosure, a method for reducing root resorption by accelerating aligner treatment is described. The method may include providing instructions for treating the teeth of a patient that are treated with orthodontic aligners in a pre-determined sequence. The teeth may be treated with each aligner for a treatment duration. For at least one aligner, the instructions for treating the teeth may include instructions for accelerating teeth movement by mechanically stimulating, using a vibrational dental device, the teeth of the patient at a frequency higher than about 80 Hz for about five minutes daily while the patient is wearing the aligner. The treatment duration for the at least one aligner may be about 14 days or any fewer number of days. The acceleration of teeth movement due to the mechanical stimulation may reduce root resorption of the patient's teeth.

According to another exemplary embodiment of the present disclosure, a method for treating a patient experiencing root resorption in aligner treatment is described. The method may include obtaining orthodontic aligners. The orthodontic aligners may be configured to be worn in the mouth of a patient in a pre-determined sequence to move the patient's teeth substantially into a desired alignment. The method may further include obtaining a vibrational dental device configured to vibrate at a frequency higher than about 80 Hz. The method may also include treating the teeth of a patient with the orthodontic aligners in the pre-determined sequence, and mechanically stimulating, using the vibrational dental device, the teeth of the patient for about five minutes daily while the patient is wearing each orthodontic aligner. The treatment may reduce root resorption of the patient's teeth during aligner treatment.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims. It is to be understood that both the foregoing general description and the following detailed description are examples and explanatory only and are not restrictive of the disclosed embodiments as claimed. The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

FIG. 1A is a perspective view of an exemplary vibrational dental device, according to embodiments of the present disclosure.

FIG. 1B is a partial perspective view of the exemplary vibrational dental device of FIG. 1A, according to embodiments of the present disclosure.

FIG. 10 is a component view of the exemplary vibrational dental device of FIG. 1A, according to embodiments of the present disclosure.

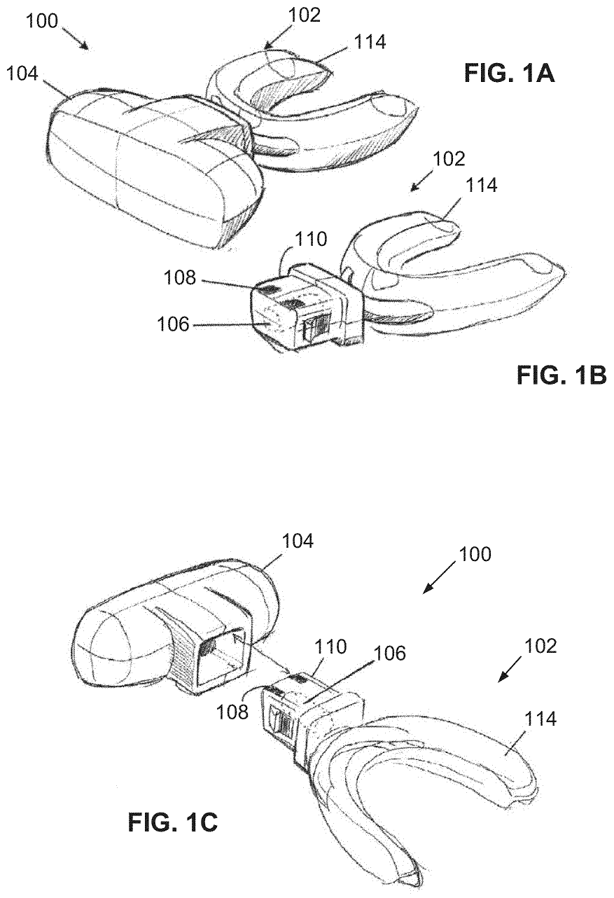

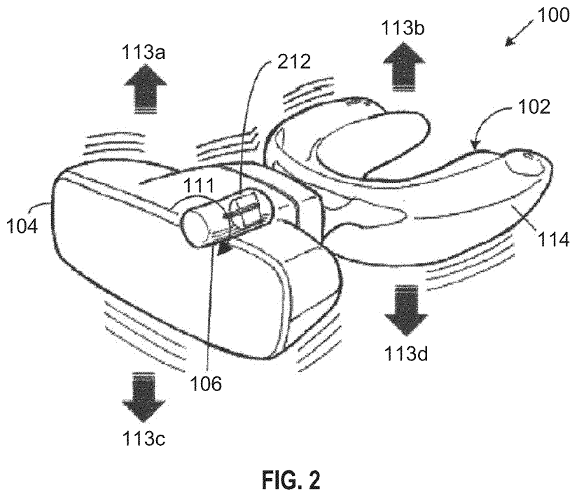

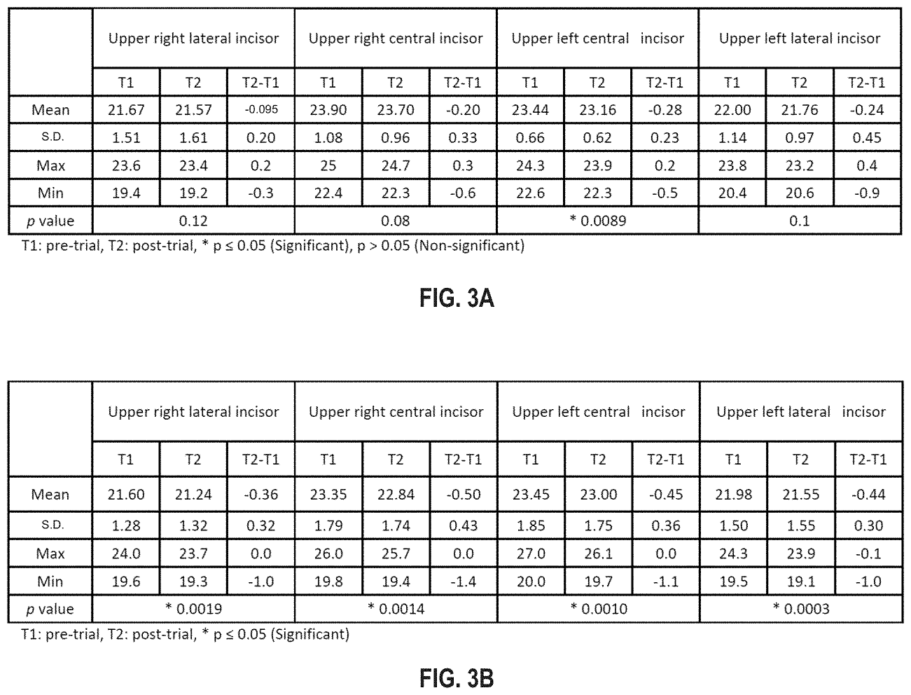

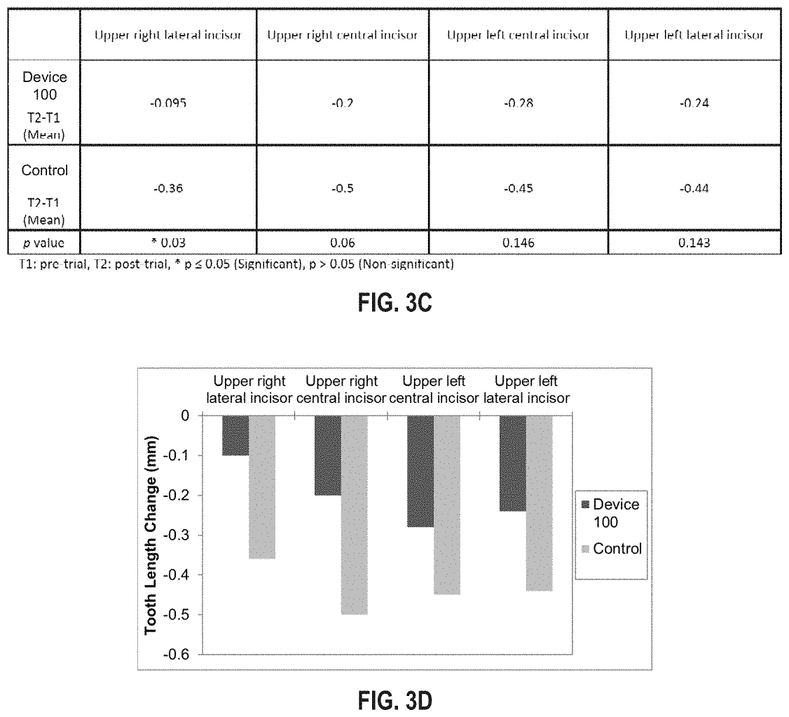

FIG. 2 illustrates an operation of the exemplary vibrational dental device of FIG. 1.

FIGS. 3A-4 summarize the results of Example 1.

### DETAILED DESCRIPTION

Exemplary embodiments are described with reference to the accompanying drawings. The drawings are not necessarily drawn to scale. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It should also be noted that as used herein and in the appended claims, the singular forms “ ” “an,” and “the” include plural references unless the context clearly dictates otherwise. Additionally, it should be noted that as used herein and in the appended claims, the term “plurality” refers to any number greater than one (for example, a plurality of aligners is any number of aligners greater than a single aligner).

The disclosed embodiments relate to devices, systems, and methods for reducing root resorption during orthodontic treatment using vibration. Advantageously, embodiments of the present disclosure can reduce root resorption while maintaining the desired movement of the teeth during the orthodontic treatment.

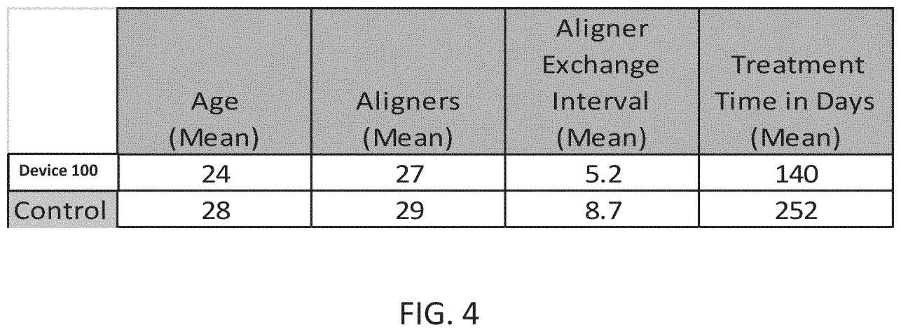

FIG. 1A is a perspective view of an exemplary vibrational dental device 100. FIG. 1B is a partial perspective view of vibrational dental device 100. FIG. 10 is a component view of vibrational dental device 100. As shown in FIGS. 1A-1C, vibrational dental device 100 includes a mouthpiece 102, a base 104, and a motor 106. Mouthpiece 102 is removably attached to base 104. Mouthpiece 102 includes a biteplate 114 and a mouthpiece extension 110 configured to connect with base 104.

In some embodiments, mouthpiece 102 and/or biteplate 114 can be configured to engage some or all of a user's teeth. For example, in the exemplary embodiments shown in FIGS. 1A-2, mouthpiece 102 and/or biteplate 114 are shaped to engage some or all of a user's teeth. As described herein, the shape of mouthpiece 102 and/or biteplate 114 shown in FIGS. 1A-2 is only exemplary. Mouthpiece 102 and/or biteplate 114 may have a U-shape or a C-shape as depicted, or a customized shape suitable for safe application of vibrational treatment to all or some of a user's teeth, or even a single tooth, and/or sitting against an orthodontic aligner on the user's teeth. In some embodiments, mouthpiece 102 and/or biteplate 114 may have any suitable shape to sit against the occlusal surface, the labial surface, or the lingual surface of the orthodontic aligner over the user's teeth. In some embodiments, biteplate 114 may have surface textural and topographical variations, such as ridges, corresponding to surface variations of the occlusal surface of the orthodontic aligner over the user's teeth. As a non-limiting example, mouthpiece 102 and/or biteplate 114 can have any suitable shape or surface texture to contact all or selected occlusal surfaces of the orthodontic aligner. The mouthpiece can be made to apply vibration directly to a user's teeth, or to aligners or other appliances applied to the teeth. Extension 110 may further include contacts 108 that electrically connect base 104 with motor 106.

As shown in FIGS. 1B and 1C, motor 106 is installed in extension 110 of mouthpiece 102. When mouthpiece 102 is attached to base 104, motor 106 resides in base 104. Base 104 further includes electronic circuitries (not shown), including a control circuitry and a power circuitry, for operating motor 106. Motor 106 may be any type of motor that can cause mouthpiece 102 or biteplate 114 to vibrate. For example, motor 106 could be a vibration motor, piezoelectric motor, a linear motor, or an electromagnetic motor. The frequency and/or strength of vibration caused by motor 106 can be adjusted by changing the voltage or current supplied to motor 106 by the electronic circuitries in base 104. For example, the voltage used for operating motor 106 may range from about 0.5 volt to about 4 volts. The current supplied to an exemplary motor 106 may range from about 65 mA to about 100 mA.

Motor 106 may have any suitable mechanical configurations to cause mouthpiece 102 or biteplate 114 to vibrate axially. FIG. 2 illustrates an exemplary operation of vibrational dental device 100. As shown in FIG. 2, in one embodiment, motor 106 is a counter-weighted motor with a longitudinal axis parallel to the longitudinal axis of extension 110. Motor 106 may include a counterweight 212 that is off-axis from the longitudinal axis of motor 106. In an exemplary embodiment, when the motor 106 rotates, as shown by the arrow 111 in FIG. 2, counterweight 212 moves up and down, causing the mouthpiece 102 to vibrate up and down, as shown by the arrows 113a-113d in FIG. 2. The vibrator can be arranged to create vibration in two or three axes. Accordingly, when the exemplary mouthpiece 102 is placed between a user's teeth, and when exemplary vibrational dental device 100 is turned on, the vibration of mouthpiece 102 will apply a vibratory force on the occlusal surfaces of the teeth. For example, biteplate 114 of mouthpiece 102 in an exemplary embodiment may cyclically move axially between the occlusal surfaces of the teeth. In other embodiments, the biteplate 114 of mouthpiece 102 may cyclically move in one or more of the three spatial axes.

In some embodiments, vibrational dental device 100 may further include one or more sensors (not shown), such as piezoelectric sensors, configured to detect the acceleration magnitude and/or frequency of the vibration of mouthpiece 102. For example, sensors may be placed on the outside or the inside edge of biteplate 114, proximate to the occlusal surfaces of the teeth when mouthpiece 102 is clamped between the occlusal surfaces. The sensors can be electrically connected to the electronic circuitries in base 104. Measurements of the sensors can be fed back to the control circuitry of motor 106 to adjust the acceleration magnitude and/or frequency of motor 106. For example, the detected acceleration magnitude and/or frequency may be compared to a desired acceleration magnitude and/or frequency, and the voltage and/or current supplied to motor 106 can be adjusted based on the comparison.

In some embodiments, motor 106 is configured to vibrate mouthpiece 102 at a frequency between about 20 Hz to about 250 Hz. In some embodiments, motor 106 can be configured to vibrate mouthpiece 102 at a frequency lower than 80 Hz between about 20 Hz to 30 Hz, between about 30 Hz to about 40 Hz, between about 40 Hz to about 50 Hz, between about 50 Hz to about 60 Hz, between about 60 Hz to about 70 Hz, or between about 70 Hz to about 80 Hz.

In other embodiments, motor 106 is configured to vibrate mouthpiece 102 at a frequency higher than 80 Hz, such as at a frequency between about 120 Hz to about 130 Hz, between about 110 Hz to about 120 Hz, between about 100 Hz to about 110 Hz, between about 90 Hz to about 100 Hz, between about 80 Hz to about 90 Hz, between about 80 Hz to about 100 Hz, between about 90 Hz to about 110 Hz, between about 100 Hz to about 120 Hz, between about 110 Hz to about 130 Hz, between about 120 Hz to about 140 Hz, or between about 100 Hz to about 140 Hz, and more specifically at a frequency at or about 100 Hz or 120 Hz. Motor 106 may be further configured to vibrate mouthpiece 102 at an acceleration magnitude ranging between about 0.01 G and about 1 G, such as an acceleration magnitude ranging between about 0.03 G and about 0.2 G. As described herein, the vibrational frequency of mouthpiece 120 may vary from the rated “free-air” vibrational frequency of motor 106 due to the amount of biting force or load applied to mouthpiece 102, such as the force used to clamp vibrational dental device 100 in place. For example, when motor 106 is configured to vibrate at a frequency of or about 120 Hz, adding biting force or load to mouthpiece 102 may result in a lower vibrational frequency of mouthpiece 102 ranging from about 100 Hz to about 120 Hz.

In some embodiments, vibrational dental device 100 can be used for applying vibrational treatment to all or some of a patient's teeth for a daily treatment period. The daily treatment period can be, for example, less than about 20 minutes, 15 minutes, 10 minutes, 6 minutes, 5 minutes, 4 minutes, or less. It is contemplated that in other embodiments the treatment period could be any value within the range of about 1 minute and 19 minutes daily, and that the daily total treatment period could be formed of a plurality of treatment sessions contributing to the daily total treatment period. In some embodiments, vibrational treatment of a patient's teeth may be applied over an orthodontic treatment duration, such as an aligner treatment duration over about 5 to about 7 days, about 7 days to about 14 days, or about 14 days to about 30 days.

Example 1 described below illustrates the use of vibrational dental device 100 operating under these variables and its clinically relevant effects.

### Example 1

A retrospective, observational clinical study was conducted to investigate the extent of root resorption during clear aligner treatment, with and without vibration treatment by an exemplary device 100. The study evaluated cone beam computed tomographic radiographs for 20 subjects (17 females and 3 males) with average age 26±11 years. All subjects had class I malocclusion of the teeth, good oral hygiene, complete permanent dentition (except third molars), and initial anterior crowding ranging from 3 to 5 mm. Subjects with external apical root shortening observed at the pre-operative radiographic examination were excluded. Extraction of premolars and dental stripping were not included in the study.

All subjects were treated with a plurality of Smartrack™ aligners, each having the default prescription level for tooth movement distance, until treatment was completed (that is, upper and lower crowding were at 0.0 mm for all subjects at the completion of treatment). Ten subjects were treated with the aligners in conjunction with daily vibration (“vibration group”), and ten subjects were treated with the aligners without vibration (“control group”). Each subject in the vibration group was treated with exemplary device 100 daily with about 120 Hz cyclical vibration for about five minutes per day, while wearing their current aligner and biting on mouthpiece 102. Subjects in the control group were not treated with device 100. Cone beam computed tomography (CBCT) scans were taken for all subjects before orthodontic treatment (T1) and after orthodontic treatment (T2). CBCT measurements were made twice by a single examiner in order to obtain more reliable tooth length readings over a treatment period of 15 days.

The sample size of the study was calculated with G Power version 3.1.9.2, based on 5% statistically significant level and power of 80% to detect meaningful differences of 0.4 mm between the groups. According to these calculations, the sample size of this research was adequate to demonstrate differences in the degree of root resorption between the groups studied.

Root resorption was calculated by assessing the difference in the total tooth length, i.e., difference between T1 and T2 (T2−T1). To compensate for any angulation of the incisors in the CBCT slices, the upper incisors lengths were measured using 3D Cartesian coordinate system. The root apex and the middle of the incisal border of each one of the maxillary incisors were identified in the axial, sagittal and coronal sections. The 3D coordinates (X, Y and Z) of each point were obtained, and the distance between the apex and the border of the incisal edge was calculated using the following formula:

D={square root over (((X_{C}−X_{R})²+(Y_{C}−Y_{R})²+(Z_{C}−Z_{R})²))}

where D is the tooth length, X is the transversal position (relation to X-axis), Y is the anteroposterior position (relation to Y-axis), Z is the vertical position (relation to X-axis), C is the point on the incisal edge, and R is the point root apex. Root resorption was calculated by assessing the difference in the total root length between T1 and T2. Maxillary incisors were selected for the evaluation of root resorption because these teeth have been found to be affected by resorption more than other teeth in the mouth.

FIG. 3A presents a paired t-test for the measured tooth length of each incisor at T1 and T2 for the vibration group, and changes in tooth length between T1 and T2 (T2−T1). Measurements of tooth length were in millimeters. The vibration group demonstrated non-statistically significant root resorption in the right lateral incisor (mean=0.095 mm, p=0.12), the right central incisor (mean=0.2 mm, p=0.08), and the left lateral incisor (mean=0.24 mm, p=0.1), and statistically significant root resorption in the left central incisor (mean=0.28 mm, p=0.008).

FIG. 3B presents a paired t-test for the measured tooth length of each incisor at T1 and T2 for the control group, and changes in tooth length between T1 and T2 (T2−T1), Measurements of tooth length were in millimeters. The control group demonstrated statistically significant root resorption in the right lateral incisor (mean=0.36 mm, p=0.0019), the right central incisor (mean=0.5 mm, p=0.0014), the left central incisor (mean=0.45 mm, p=0.001), and the left lateral incisor (mean=0.43 mm, p=0.0003).

FIGS. 3C and 3D present an unpaired t-test for tooth length changes between the vibration group and the control group. Measurements of tooth length were in millimeters. As shown in FIGS. 3C and 3D, there was a statistically significant difference between the vibration and control groups in the right lateral incisors (p=0.03). There was a non-statistically significant difference between the vibration and control groups in the right central incisor (p=0.06), the left central incisor (p=0.146), and the left lateral incisor (p=0.143).

The results of the Example 1 demonstrate that all examined teeth undergoing orthodontic treatment experienced root resorption. However, the resorption was mostly non-significant in the vibration group (FIG. 3A) while it was significant in all four incisors in the control group (FIG. 3B). In addition, the intergroup comparison (FIGS. 3C and 3D) demonstrated less root resorption for the vibration group for each incisor, while simultaneously decreasing overall treatment time. FIG. 4 compares the average age, average number of aligners used, average aligner exchange interval, and average treatment time in days of the subjects between the vibration group and the control group. As shown in FIG. 4, on average, to achieve treatment completion, subjects in the vibration group were subject to less number of aligner exchanges and shorter aligner exchange intervals over an overall shorter treatment duration. Decreased treatment duration has been suggested as a factor in decreasing the risk of root resorption. Advantageously, the results of this study support the conclusion that high frequency mechanical vibration may enhance faster tooth movement, while simultaneously reducing root resorption.

Possible factors for the reduced root resorption associated with the vibration group may include the biological response of the human tissues due to the vibration, such as increased blood circulation and altered tissue perfusion within target tissues. The increased vascularity and circulation associated with vibration with device 100 may minimize hyalinization, thus leading to less orthodontic induced root resorption. High-frequency vibration may additionally increase trabecular bone formation and prevent bone loss associated with aging. Moreover, vibration with device 100 may also increase levels of cytokines in the body. Cytokines play an important role in eliminating the necrotic tissues involved in orthodontic root resorption.

Based on the results of the current study, the vibration group and the control group experienced a reduction in root length. However, in the vibration group treated with device 100, the reduction was reduced compared to the control group. Additionally, the root reduction of the vibration group was mostly non-significant. This may suggest that high-frequency vibration with device 100 may beneficially reduce the effects of root resorption during orthodontic treatment. In addition, all subjects in the vibration group achieved upper and lower crowding of 0.0 mm at the completion of treatment (T2), suggesting that treatment with device 100 did not impede or otherwise negatively affect the course of orthodontic treatment. In fact, as shown in FIG. 4, the course of orthodontic treatment was accelerated for the vibration group subject to treatment with device 100 comparing to that of the control group.

While the description herein is directed to orthodontic aligners, the instant disclosure is applicable to other orthodontic modalities where a static force is applied to one or more teeth over a period of time, for example bracket-and-wire braces or other orthodontic appliances.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, failing within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A method for treating a patient experiencing root resorption in aligner treatment, the method comprising:
providing a vibrational dental device configured to vibrate at a frequency higher than about 80 Hz; and
providing instructions for treating the teeth of a patient with orthodontic aligners, the aligners configured to be worn in the mouth of the patient in a pre-determined sequence to move the patient's teeth substantially into a desired alignment, wherein the instructions for treating include
instructions for mechanically stimulating, using the vibrational dental device, the teeth of the patient for about five minutes daily while the patient is wearing the aligners,
wherein the treatment reduces root resorption of the patient's teeth during aligner treatment.

2. The method of claim 1, wherein the mechanical stimulation reduces root resorption of the patient's teeth by between about 10% and about 75%.

3. The method of claim 1, wherein the device is configured to vibrate at an acceleration magnitude ranging between about 0.01 G and about 1 G.

4. The method of claim 1, further comprising mechanically stimulating the teeth at a frequency between about 100 Hz and about 120 Hz.

5. The method of claim 1, further comprising mechanically stimulating the teeth at a g-force between about 0.01 G and about 1 G.

6. The method of claim 1, further comprising treating the teeth with each aligner in the pre-determined sequence until the teeth are substantially in the desired alignment.

7. The method of claim 1, wherein the device comprises a mouthpiece and a motor connected to and configured to vibrate the mouthpiece.

8. The method of claim 7, further comprising providing the mouthpiece between occlusal surfaces of the teeth to be clamped by the teeth.

9. The method of claim 7, further comprising detecting vibration characteristics of the mouthpiece.

10. The method of claim 1, further comprising adjusting the frequency and/or g-force of the vibration of the device.

11. The method of claim 1, wherein the mechanical stimulation accelerates movement of the teeth substantially into the desired alignment.

12. The method of claim 1, wherein the teeth are treated with each aligner for a treatment duration of less than 14 days.

13. The method of claim 1, wherein the mechanical stimulation of the teeth with the device reduces a treatment time of the aligner treatment by at least about 50%.

14. A method for reducing root resorption by accelerating aligner treatment, the method comprising:
providing instructions for treating the teeth of a patient that are treated with orthodontic aligners in a pre-determined sequence for a treatment duration;
wherein for at least one aligner, the instructions for treating the teeth include instructions for accelerating teeth movement by mechanically stimulating, using a vibrational dental device, the teeth of the patient at a frequency higher than about 80 Hz for about five minutes daily while the patient is wearing the at least one aligner, the treatment duration for the at least one aligner being about 14 days or fewer; and
wherein the acceleration of teeth movement due to the mechanical stimulation reduces root resorption of the patient's teeth.

15. The method of claim 14, wherein the acceleration reduces root resorption of the patient's teeth by between about 10% and about 75%.

16. The method of claim 14, wherein the device is configured to vibrate at an acceleration magnitude ranging between about 0.01 G and about 1 G.

17. The method of claim 14, further comprising mechanically stimulating the teeth at a frequency between about 100 Hz and about 120 Hz.

18. The method of claim 14, further comprising mechanically stimulating the teeth at a g-force between about 0.1 G and about 1 G.

19. The method of claim 14, wherein the mechanical stimulation of the teeth with the device reduces a treatment time of the aligner treatment by at least about 50%.

20. A dental device for reducing root resorption in aligner treatment, the dental device comprising means for
mechanically stimulating teeth of a patient at a frequency higher than about 80 Hz for about 5 minutes daily while the patient is wearing an aligner; and
reducing root resorption of the patient's teeth.

21. A method for treating a patient experiencing root resorption in aligner treatment, the method comprising:
obtaining orthodontic aligners, the orthodontic aligners configured to be worn in the mouth of a patient in a pre-determined sequence to move the patient's teeth substantially into a desired alignment;
obtaining a vibrational dental device configured to vibrate at a frequency higher than about 80 Hz;
treating the teeth of a patient with the orthodontic aligners in the pre-determined sequence; and
mechanically stimulating, using the vibrational dental device, the teeth of the patient for about five minutes daily while the patient is wearing each orthodontic aligner,
wherein the treatment reduces root resorption of the patient's teeth during aligner treatment.
